(19) United States
(12) Patent Application Publication
(10) Pub. No.: US 2010/0322566 A1
(43) Pub. Date: Dec. 23, 2010

(54) CONNECTOR HAVING AN IMPROVED INSULATIVE HOUSING

(75) Inventors: QI-SHENG ZHENG, Kunshan (CN); JIA-YONG HE, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/818,179

(22) Filed: Jun. 18, 2010

(30) Foreign Application Priority Data
Jun. 18, 2009 (CN) 200910303376.9

(51) Int. Cl. G02B 6/38; H01R 13/648

(52) U.S. Cl. 385/74; 439/607.01

(57) ABSTRACT

A connector (100) having a chamber (101) for insertion of a plug includes an insulative housing having a base portion (11), a tongue plate protruding forwardly into the chamber, a standoff (13) located below the base portion (11) and extending forwardly, and a cavity (15) formed between a lower surface of the base portion and an upper surface of the standoff, the standoff (13) having an opening (136) passing therethrough along a height direction of the connector and communicating with the cavity (15) for exposing key point of the lower surface to exterior; a set of contacts (3) retained in the tongue plate for mating with the plug; and a metal shell (5) assembled to the insulative housing and supported upwardly by the standoff (13), the metal shell having a bottom wall (53) received in the cavity (15).

### BACKGROUND OF THE INVENTION

1. Field of the Invention

The present invention relates to a connector, more particularly to a connector having an improved insulative housing.

2. Description of Related Art

A conventional connector usually comprises an insulative housing, a plurality of contacts retained in the insulative housing for mating with a plug, and a metal shell shielding the insulative housing and forming a chamber for receiving the plug. The insulative housing has a base portion, a tongue plate extending forwardly into the chamber from the base portion for supporting the contacts, a standoff extending forwardly from the base portion and parallel to the tongue plate, and a cavity formed between a lower surface of the base portion and an upper surface of the standoff. The metal shell has a top wall covering an upper surface of the base portion and a bottom wall covering the lower surface of the base portion. The bottom wall is supported upwardly by the standoff and is retained in the cavity.

However, the standoff which is located under and covers the lower surface of the base portion must be destroyed for exposing the lower surface of the base portion to exterior so as to measure a height difference between the lower surface of the base portion and the lower surface of the tongue plate or surfaces of other portions of the insulative housing and calculate dimensional precisions of the insulative housing.

Hence, an improved connector with is desired to overcome the above problems.

### BRIEF SUMMARY OF THE INVENTION

According to one aspect of the present invention, a connector having a chamber for insertion of a plug comprises an insulative housing having a base portion, a tongue plate protruding forwardly into the chamber, a standoff located below the base portion and extending forwardly, and a cavity formed between a lower surface of the base portion and an upper surface of the standoff, the standoff having an opening passing therethrough along a height direction of the connector and communicating with the cavity for exposing key point of the lower surface to exterior; a plurality of contacts retained in the tongue plate for mating with the plug; and a metal shell assembled to the insulative housing and supported upwardly by the standoff. The metal shell has a bottom wall received in the cavity.

According to another aspect of the present invention, a connector comprises a metal shell having a chamber surrounded by a top wall, a bottom wall opposite to the top wall, and a pair of side walls connecting the top wall and the bottom wall; an insulative housing being shielded by the metal shell and comprising a base portion, a tongue plate protruding forwardly into the chamber, a standoff located below the base portion and extending forwardly for supporting the bottom wall upwardly, and a cavity formed between a lower surface of the base portion and an upper surface of the standoff for retaining a retaining tab formed on the bottom wall, the standoff having openings passing therethrough along a height direction of the connector and communicating with the cavity for exposing key points of the lower surface to exterior so that a height difference between the lower surface of the base portion and surfaces of other portions of the insulative housing will be measured via probes of a probe measuring device or other measurement tools conveniently; and a plurality of contacts disposed on the tongue plate for mating with the plug.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of a connector according to the present invention;

FIG. 2 is similar to FIG. 1, but viewed from another aspect;

FIG. 3 is a partly exploded view of the connector shown in FIG. 1;

FIG. 4 is an exploded view of the connector shown in FIG. 1;

FIG. 5 is similar to FIG. 4, but viewed from another aspect; and

FIG. 6 is a perspective view of a first insulative housing of the connector shown in FIG. 1.

FIG. 7 similar to FIG. 6, but viewed from a second aspect;

FIG. 8 similar to FIG. 6, but viewed from a third aspect.

### DETAILED DESCRIPTION OF THE PREFERRED EMBODIMENT

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

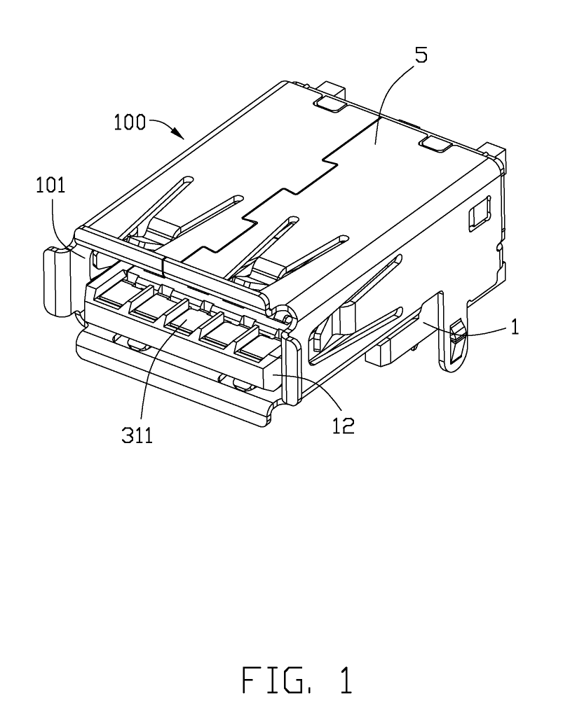

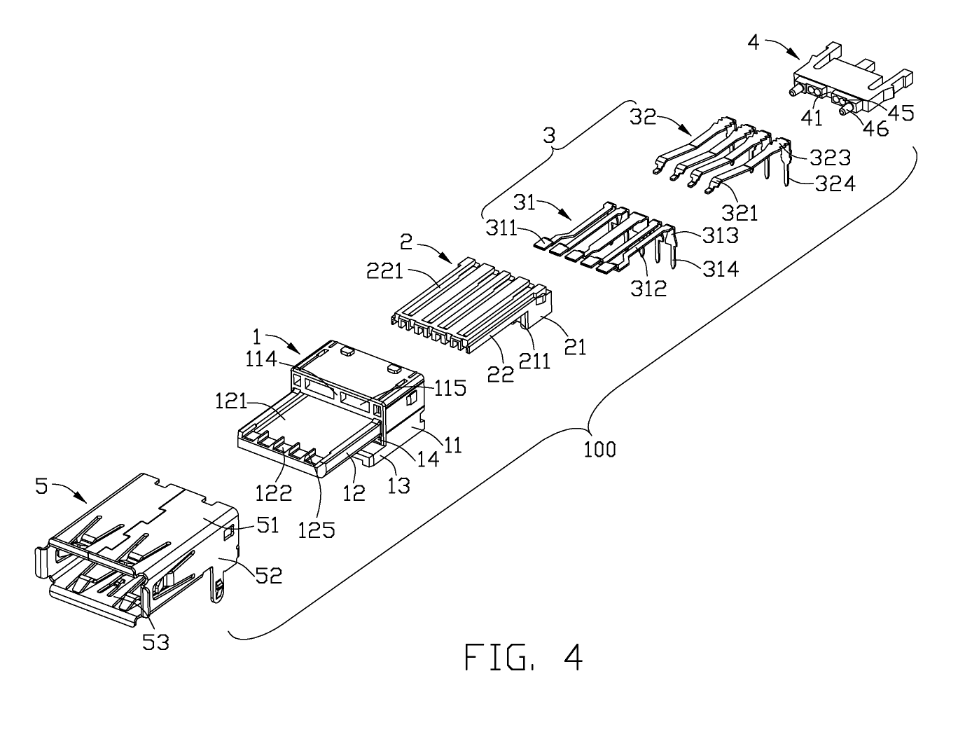

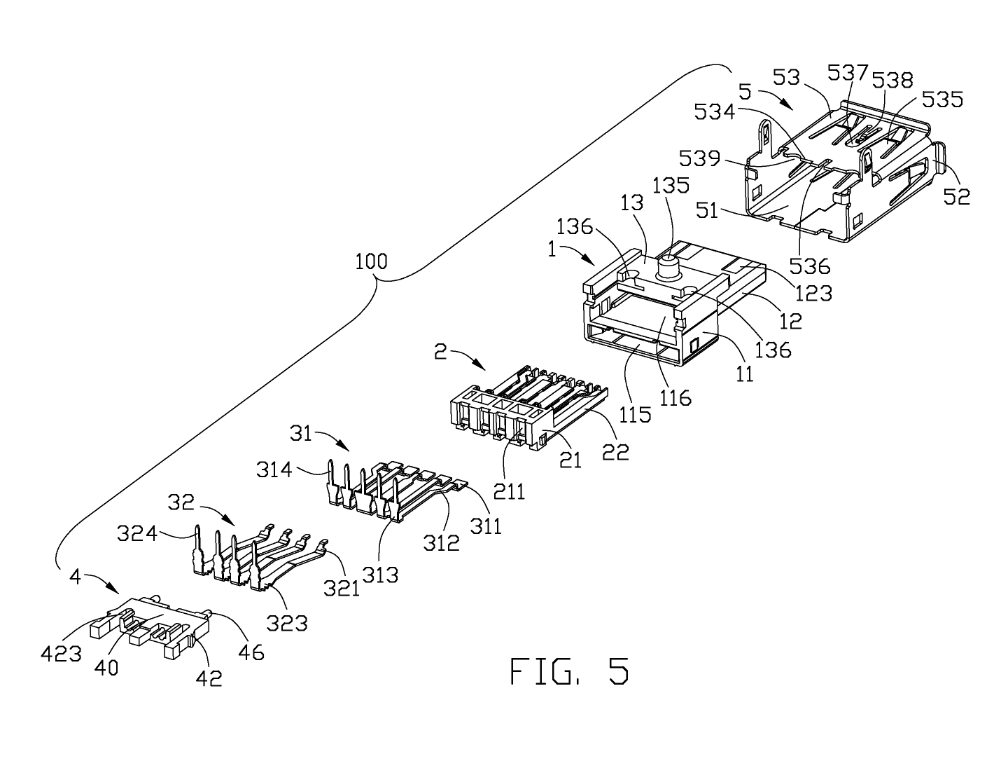

Referring to FIGS. 1, 4 and 5, A connector 100 according to the present invention for being mounted to a printed circuit board (PCB, not shown) is disclosed. The connector 100 is adapted to non-simultaneously receive a standard A-type USB 2.0 plug, a standard A-type USB 3.0 plug, and an optical plug. The connector 100 includes a first insulative housing 1, a second insulative housing 2 coupled to the first insulative housing 1, a set of electrical contacts 3 retained in the second insulative housing 2, a metal shell 5 enveloping the first insulative housing 1 and forming a chamber 101 for receiving a corresponding plug (not shown), and an optical module 4 retained in the first insulative housing 1 for transmitting optical data.

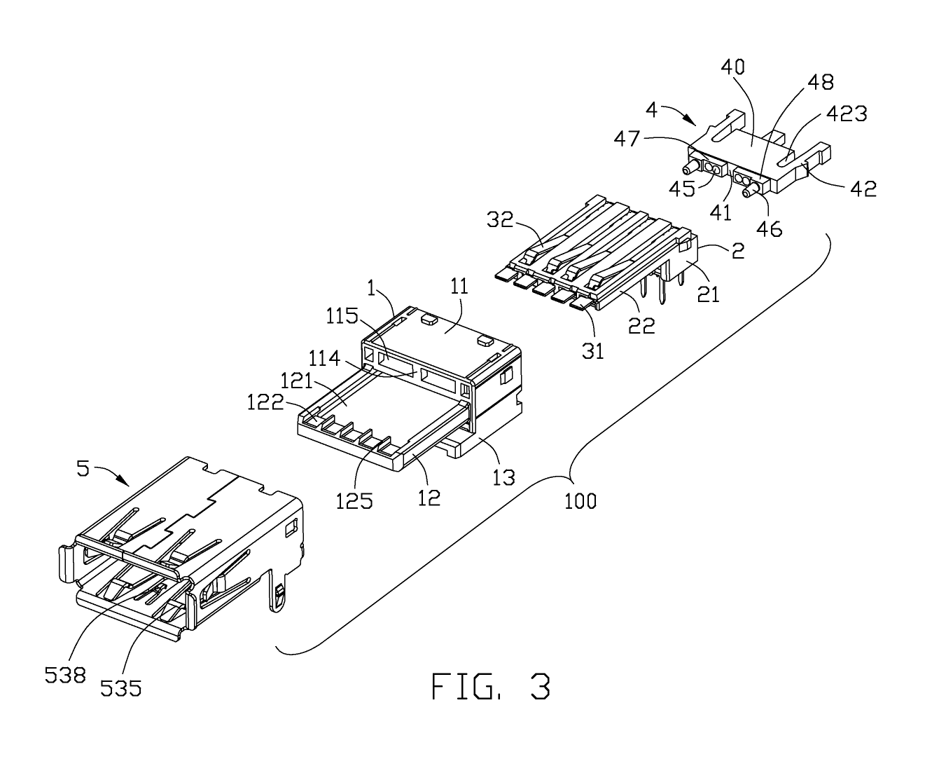

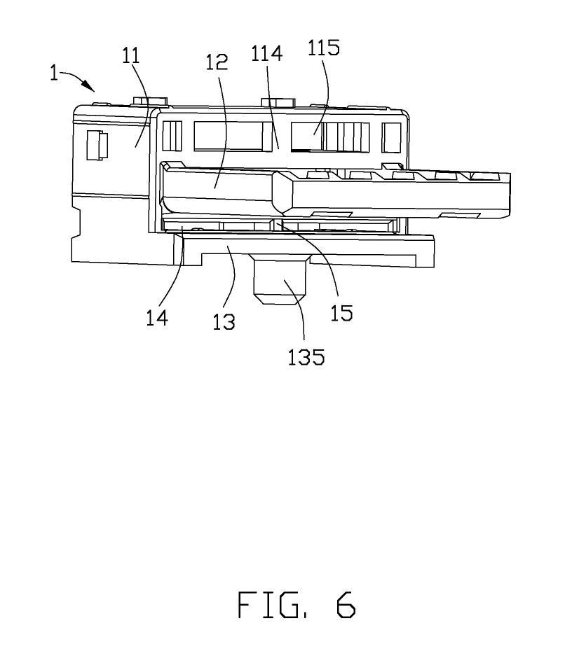

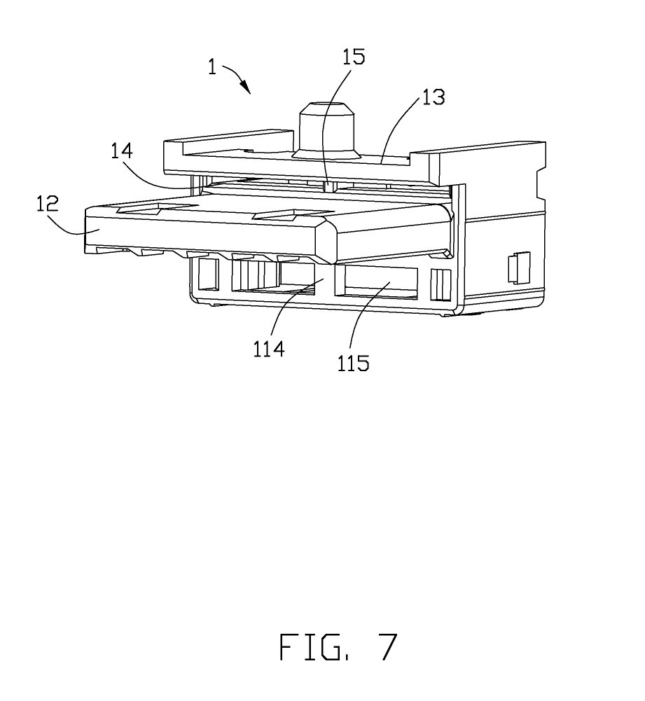

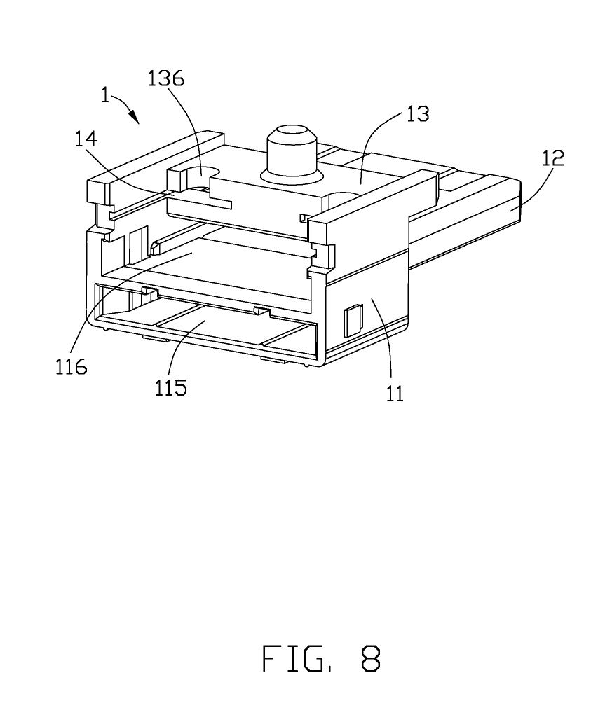

Referring to FIGS. 1-8, the first insulative housing 1 includes a base portion 11, a first protruding portion 12 extending forwardly from a front face of the base portion 11, a standoff 13 located below the base portion 11 for supporting the metal shell 5 upwardly, and a cavity 14 formed between an upper surface of the standoff 13 and a lower surface of the base portion 11. The standoff 13 extends forwardly and is parallel to the first protruding portion 12. An embossment 15 is formed in the midst of the cavity 14 and connects the standoff 13 and the base portion 11. The standoff 13 has a post 135 extending downwardly from a lower surface thereof, and a pair of openings 136 passing therethrough and communicating with the cavity 14 for exposing key points of the lower surface of the base portion 11 to exterior. The lower surface of the base portion 11 is exposed to the exterior through the openings 136; the height difference between the lower surface of the base portion 11 and an upper surface of the base portion 11 or a lower surface of the first protruding portion 12 or surfaces of other portions will be measured via probes of a probe measuring device or other measurement tools conveniently. The base portion 11 has a receiving slot 115 for receiving the optical module 4 and locating above the first protruding portion 12, and a retaining slot 116 locating below the receiving slot 115. The openings 136 are located at back of the standoff 13 and passing a back face of the standoff to communicate with the retaining slot 16, and the cavity 14 passes through the standoff backwardly to communicate with the retaining slot 16. A block 114 is located at front and midst of the receiving slot 115 for resisting the optical module 4 backwardly. The first protruding portion 12 has a receiving space 121 recessed downwardly from an upper surface thereof and communicating with the retaining slot 116. The first protruding portion 12 has a set of ribs 125 extending upwardly from the upper surface thereof and located at front of the receiving space 121, and forms a set of grooves 122 exposed to the exterior and located between each two adjacent ribs 125.

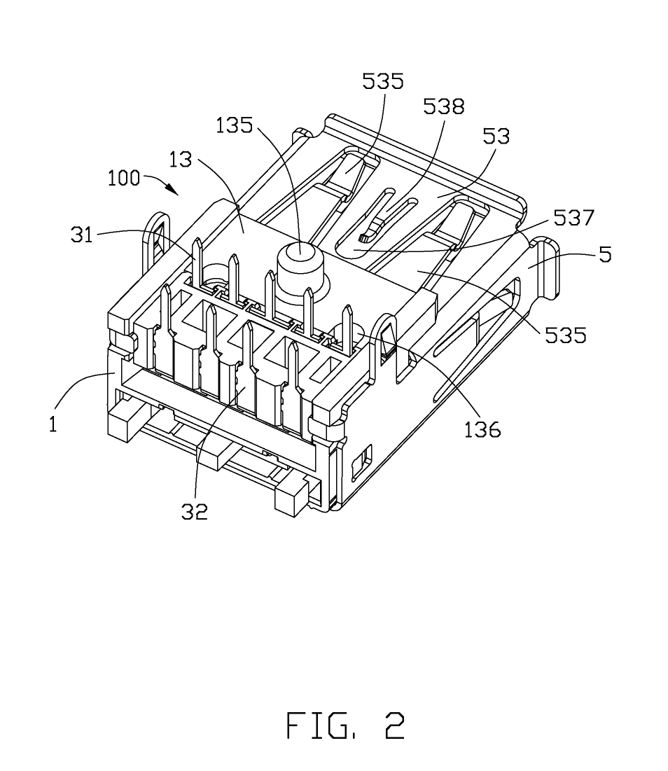

Referring to FIGS. 2-5, the contacts 3 are adapted for USB 3.0 protocol, and include a number of first contacts 31 and a number of second contacts 32. The first contacts 31 include a pair of first differential contacts arranged at a right side thereof, a pair of second differential contacts arranged at a left side thereof, and a first grounding contact located between the pair of first and the pair of second differential contacts. The second contacts 32 are adapted for USB 2.0 protocol and include a power contact arranged at a left side thereof, a second grounding contact arranged at a right side thereof, and a third pair of differential contacts located between the power contact and the third grounding contact.

The second insulative housing 2 includes a main portion 21 retained in the retaining slot 116, and a second protruding portion 22 extending forwardly from the main portion 21 and retained in the receiving space 121. The main portion 21 has a set of securing slots 211 arranged in a front and back surfaces thereof and extending along a height direction of the connector 100. The second protruding portion 22 has a set of passageways 221 arranged in an upper and lower surface thereof and extending along a front-to-back direction. The first contacts 31 include stiff first contacting portions 311 extending forwardly beyond the second protruding portion 22 and received in the corresponding grooves 122, first connecting portions 312 extending downwardly and backwardly from the first contacting portions 311 and along a horizontal plan for being received in the passageways 221 on the lower surface of the second protruding portion 22, first retaining portions 313 bending downwardly from back ends of the first connecting portions 312 and retained in the securing slots 211 on the front surface of the main portion 21, and first tail portions 314 extending downwardly from the corresponding first retaining portions 313 for being mounted on the PCB. The second contacts 32 include resilient second contacting portions 321 retained in the passageways 221 on the upper surface of the second protruding portion 22 and protruding upwardly beyond the upper surface, second retaining portions 323 extending backwardly from back ends of the corresponding second contacting portions 321 for being retained in the corresponding passageways 221 on the upper surface of the second protruding portion 22 and bending downwardly for being retained in the corresponding securing slots 211 on the back surface of the main portion 21, and second tail portions 324 extending downwardly from lower ends of the second retaining portions 323 for being mounted on the PCB. The second contacting portions 321 extend downwardly beyond the first contacting portions 311 and are located behind the first contacting portions 311. The first and second contacts 31, 32 are assembled to the second insulative housing 2 together to form as a contact module for being assembled to the first insulative housing 1. The first insulative housing 1 and the second insulative housing 2 are assembled together to form an insulative housing. The first protruding portion 12 and the second protruding portion 22 are coupled together to form a tongue plate protruding into the chamber 101 for mating with a corresponding plug. In another embodiment, the first insulative housing 1 and the second insulative housing 2 could be integrally formed as the insulative housing; the first contacts 31 could be insert molded into the second insulative housing 2.

Referring to FIGS. 2-5, the optical module 4 is assembled to the first insulative housing 1 and is located above the second insulative housing 2. The optical module 4 has a main body 40, a first and second parts 47, 48 extending forwardly from the main body 40, and a recess 41 located between the first and the second parts 47, 48. Each of the first and second parts 47, 48 has a pair of lenses 45 disposed on a front end thereof. The optical module 4 has a pair of columniations 46 extending forwardly from the front ends of the respective first and second parts 47, 48 and located at two sides of the lenses 45. The optical module 5 further includes a set of fibers (not shown) assembled in the main body 40 to optically couple with the respective lenses 45. The optical module 4 is assembled to the first insulative housing 1 from a rear end of the first insulative housing 1. The block 114 is retained in the recess 41 and resists the main body 40 backwardly. The main body 40 has a pair of resilient latches 42 formed at two lateral sides thereof for latching with the base portion 11 to prevent the main body 40 moving backwardly. A slit 423 is formed between the latch 42 and the main body 40, therefore, when the optical module 4 is inserted into the receiving slot 115, the latches 42 are deflected, and the optical module 4 will enter into the receiving slot 115 easily. The lenses 45 are exposed to the chamber 101 so as to optically mate with the corresponding plug. The columniations 46 protrude into the chamber 10 so as to mate with a pair of holes on the corresponding plug.

The metal shell 5 includes a top wall 51 covering a top surface of the base portion 11, a bottom wall 53 opposite to the top wall 51, and a pair of side walls 52 connecting the top wall 51 and the bottom wall 53. The bottom wall 53 has a retaining tab 534 extending backwardly for being retained in the cavity 14 and a fixing slot 536 formed on the retaining tab 534 for being retained on the embossment 15. The standoff 13 resists the bottom wall 53 upwardly for preventing the bottom wall 53 from deformation. The bottom wall 53 has a pair of first spring fingers 535 extending forwardly, and a second spring finger 538 extending backwardly and locating between the first spring fingers 535. The first protruding portion 12 has a pair of depressions 123 recessed upwardly from the lower surface thereof for accommodating the first springs 535 when the first springs 535 have large deflection. The retaining tab 534 has a pair of notches 539 at two lateral sides of the fixing slot 536 for communicating with the openings 136 so as to expose the key points of the lower surface of the base portion 11 to the exterior. The bottom wall 53 has an enlarged slot 537 at back of the second spring finger 538 for exposing key points of the lower surface of the first protruding portion 12. Although the metal shell 5 is assembled to the first insulative housing 1, the lower surfaces of the base portion 11 and the first protruding portion 12 are exposed to the exterior through the enlarged slot 537 and the notches 539; the height difference between the lower surface of the protruding portion 12 and the lower surface of the base portion 11 will be measured via probes of a probe measuring device or other measurement tools conveniently.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A connector having a chamber for insertion of a plug, the connector comprising:
an insulative housing having a base portion, a tongue plate protruding forwardly into the chamber, a standoff located below the base portion and extending forwardly the base portion, and a cavity formed between a lower surface of the base portion and an upper surface of the standoff, the standoff having an opening passing therethrough along a height direction of the connector and communicating with the cavity for exposing key point of the lower surface of the base portion to exterior;
a plurality of contacts retained in the tongue plate for mating with the plug; and
a metal shell assembled to the insulative housing and supported upwardly by the standoff, the metal shell having a bottom wall received in the cavity.

2. The connector according to claim 1, wherein the metal shell has a top wall opposite to the bottom wall and covering an upper surface of the base portion, the bottom wall has a retaining tab extending backwardly therefrom for being retained in the cavity.

3. The connector according to claim 2, wherein the insulative housing has an embossment formed in the cavity and connecting the standoff and the base portion, the retaining tab has a fixing slot recessed forwardly from a back end thereof and being retained in the embossment.

4. The connector according to claim 2, wherein the retaining tab has a notch communicating with the opening for exposing the lower surface of the base portion to the exterior.

5. The connector according to claim 2, wherein the bottom wall has a pair of first spring fingers extending forwardly, and a second spring finger extending backwardly and locating between the first spring fingers, the tongue plate has a pair of depressions recessed upwardly from a lower surface thereof for accommodating the first springs when the first springs have large deflection.

6. The connector according to claim 2, wherein the bottom wall has an enlarged slot at back of the second spring finger for exposing key points of the lower surface of the tongue plate.

7. The connector according to claim 1, wherein the standoff has a post extending downwardly from a lower surface thereof for being mounted on a PCB.

8. The connector according to claim 1, wherein the base portion has a receiving slot formed therein and located above the tongue plate, the connector comprises an optical module received in the receiving slot and having lenses exposed to the chamber for transmitting optical data.

9. The connector according to claim 8, wherein the optical module has resilient latches extending at two lateral sides thereof for latching with the base portion to prevent the optical module moving backwardly.

10. The connector according to claim 9, wherein the optical module has slits formed at inner sides of the latches for the latches being deflected easily when the optical module is inserted into the receiving slot.

11. The connector according to claim 1, the insulative housing includes a first insulative housing, and a second insulative housing coupled to the first insulative housing, the first insulative housing has a first protruding portion extending forwardly from the base portion, the second insulative housing has a main portion retained in a retaining slot formed in the base portion and a second protruding portion received in a receiving space recessed downwardly from an upper surface of the first protruding portion, the opening passes through a back face of the standoff and communicates with the retaining slot.

12. The connector according to claim 11, the second protruding portion has a plurality of passageways formed on an upper and lower surfaces thereof, the contacts comprise a plurality of first contacts having resilient first contacting portions received in the passageways on the upper surface of the second protruding portion, and a plurality of second contacts having stiff second contacting portions received in a plurality of grooves formed on an upper surface of the first protruding portion and second connecting portions connecting with the second contacting portions and received in the passageways on the lower surface of the second protruding portion

13. A connector comprising:
a metal shell having a chamber surrounded by a top wall, a bottom wall opposite to the top wall, and a pair of side walls connecting the top wall and the bottom wall;
an insulative housing being shielded by the metal shell and comprising a base portion, a tongue plate protruding forwardly into the chamber, a standoff located below the base portion and extending forwardly for supporting the bottom wall upwardly, and a cavity formed between a lower surface of the base portion and an upper surface of the standoff for retaining a retaining tab formed on the bottom wall, the standoff having openings passing therethrough along a height direction of the connector and communicating with the cavity for exposing key points of the lower surface to exterior so that a height difference between the lower surface of the base portion and surfaces of other portions of the insulative housing will be measured via probes of a probe measuring device or other measurement tools conveniently; and
a plurality of contacts disposed on the tongue plate for mating with the plug.

14. The connector according to claim 13, wherein the retaining tab has notches communicating with the openings for exposing the lower surface of the base portion to the exterior.

15. The connector according to claim 13, wherein the bottom wall has a pair first spring fingers extending forwardly, and a second spring finger extending backwardly and locating between the first spring fingers, the tongue plate has a pair of depressions recessed upwardly from a lower surface thereof for accommodating the first springs when the first springs have large deflection.

16. The connector according to claim 15, wherein the bottom wall has an enlarged slot at back of the second spring finger for exposing key points of the lower surface of the tongue plate so that a height difference between the lower surface of the tongue plate and the lower surface of the base portion or surfaces of other portions of the insulative housing will be measured via probes of a probe measuring device or other measurement tools conveniently.

17. An electrical connector for use with a plug, comprising:
an insulative housing defining a base and a tongue portion extending forwardly therefrom;
a plurality of contacts disposed in the housing with contacting sections exposed upon an upper face of the tongue portion;
a metallic shell fastened to the base and including opposite top and bottom walls in a height direction and opposite two side walls in a transverse direction perpendicular to the height direction, commonly enclosing the tongue portion; and
an enlarged slot formed in the bottom wall with a spring finger extending therein for engagement with the plug; wherein
the enlarged slot leaves enough space for allowing a tool to extend therethrough for measuring a true position of the tongue portion from a bottom side of the housing.

18. The electrical connector as claimed in claim 17, wherein the housing further includes a standoff below the base with a cavity therebetween in a height direction, and said standoff forms an opening downwardly communicating the exterior for allowing said tool to extend therethrough for measuring a true position of the base from the bottom side of the housing.

19. The electrical connector as claimed in claim 18, wherein said enlarged slot defines a closed type boundary while the opening defines an open type boundary and communicates with the exterior rearwardly.
